(19) United States
(12) Patent Application Publication
(10) Pub. No.: US 2018/0166937 A1
(43) Pub. Date: Jun. 14, 2018

(54) SYNCHRONOUS RELUCTANCE MACHINE

(71) Applicant: ABB Schweiz AG, Baden (CH)

(72) Inventors: Chenjie Lin, Fuquay Varina, NC (US); Ghanshyam Shrestha, Apex, NC (US); Matthew Henriksen, Raleigh, NC (US)

(21) Appl. No.: 15/379,374

(22) Filed: Dec. 14, 2016

(51) Int. Cl. H02K 3/16; H02K 11/042; H02K 1/24

(52) U.S. Cl. CPC H02K 3/16; H02K 1/246; H02K 11/042

(57) ABSTRACT

An assembly that can enhance the power factor of synchronous reluctance (SynRel) machines. The assembly can include one or more pickup coils that are at least proximally adjacent to an outer periphery of a rotor that are structured to harvest energy in an air gap between the rotor and a stator. The harvested energy can be supplied to a rectifier that is electrically coupled to the pickup coils, and which can convert the harvested energy into DC excitation current. The DC excitation current can be provided to one or more DC field windings that extend through the rotor, such as, for example, through flux barriers in the rotor. The flow of the DC excitation current through the DC field windings can generate a flux that can be put in a rotor axis to enhance the power factor and torque rating of the SynRel machine.

### BACKGROUND

Embodiments of the present application generally relate to synchronous reluctance machines. More particularly, but not exclusively, embodiments of the present application relate to magnet free synchronous reluctance machines having an enhanced power factor through the use of harmonic power.

Conventional wind turbine generators can include permanent magnet synchronous machines (PMSM) that are used to convert rotational movement of at least a portion of the wind turbine generator into electricity. PMSMs can be selected for such applications due, at least in part, to the relatively high power density and efficiency characteristics of PMSMs. However, PMSMs often require a relatively large volume of powerful magnets, particularly when used in at least certain applications, such as, for example, when used with low gear ratio wind turbine generators, among other applications. Thus, as an alternative to the use of PMSMs, consideration has been given to the use of synchronous reluctance (SynRel) machines for at least certain types of generator applications.

SynRel machines typically do not include a means for flux production, such as, for example, coils or magnets, on the rotor side of the SynRel machine. Instead, SynRel machines generally utilize the reluctance principle to create torque. Therefore, in comparison with induction machines and machines with field excitation windings, the rotors for SynRel machines typically have relatively significantly lower losses, and thereby generally also have a lower operation temperature.

Additionally, SynRel machines, including, for example, permanent magnet assisted SynRels (PMA-SynRel), can have a certain competence in at least certain applications, including, for example, when used with relatively high gear ratio wind turbine generators. However, with respect to at least wind turbine generator applications, when in the low gear ratio range where an alternative or replacement to/for PMSM may be more beneficial, SynRel machines typically can have relatively low power factor characteristics. When compared to PMSM wind turbine generators, such relatively low power factor characteristics of SynRel machine in wind turbine generator applications can adversely impact at least the cost of energy that is generated by the wind turbine generator, and moreover, can be associated with a relatively high cost of energy. Further, attempts to compensate for such relatively low power factor characteristics of SynRel machines, including for example, through the inclusion of a relatively significant amount of rare earth permanent magnets, among other manners of compensation, can result in relatively expensive drivetrains, and can also attribute to relatively high losses and/or adversely impact the efficiency of the SynRel machine.

Additionally, low energy magnet materials, such as, for example, ferrite have also been investigated in connection with ferrite assisted SynRel (FA-SynRel) machines. However, such an approach can be generally limited to use in relatively small, or midsized, machines or applications. Further, applications in which FA-SynRel machines are generally used can be limited to certain types of operating conditions and/or the requirements of certain applications. For example, FA-SynRel machines can experience a generally higher risk of demagnetization when used in at least relatively large size machines such that the FA-SynRel machine operates under maximum electrical loading or short circuit fault conditions, and/or when FA-SynRel machines are exposed to relatively low ambient temperatures and/or cold starting conditions.

### BRIEF SUMMARY

An aspect of an embodiment of the present application is an assembly for a synchronous reluctance machine that includes a rotor and at least one pickup coil that is coupled to the rotor. The at least one pickup coil can be positioned at least proximally adjacent to an outer periphery of the rotor, and be structured to harvest energy in an air gap adjacent to the outer periphery of the rotor during operation of the synchronous reluctance machine. The assembly can further include at least one DC field winding that is electrically coupled to the at least one pickup coil. The at least one DC field winding can extend through an inner portion of the rotor and be configured to generate flux within the rotor using the harvested energy from the at least one pickup coil.

Another aspect of an embodiment of the present application is an assembly for a synchronous reluctance machine that includes a stator having an inner bore and a rotor having an outer periphery that is sized to accommodate rotational displacement of at least a portion of the rotor within the inner bore. The outer periphery can be sized for at least a portion of the rotor that is operably positioned in the inner bore to be separated from the stator by an air gap. The assembly can also include one or more pickup coils that are coupled to the rotor, and which extend at least proximally adjacent to the outer periphery of the rotor. Additionally, the one or more pickup coils can be structured to harvest energy in the air gap that is generated during operation of the synchronous reluctance machine.

Additionally, an aspect of an embodiment of the present application is an assembly for a synchronous reluctance machine that includes a stator having an inner bore and a rotor having a plurality of flux barriers, a plurality of pickup coils, and a plurality of DC field windings. The plurality of DC field windings can extend through at least a portion of the plurality of flux barriers. Additionally, the plurality of pickup coils can be adjacent to an outer periphery of at least a portion of the rotor that is sized for rotational displacement within the inner bore of the stator. Further, the plurality of pickup coils can be structured to harvest energy from at least an air gap in the inner bore between the stator and the rotor. The assembly can also include a rectifier, including, for example, a rectification circuit and/or power electronics, that is electrically coupled to the plurality of pickup coils and the plurality of DC field windings. The rectifier can be structured to convert AC current of the harvested energy from the pickup coils to DC excitation energy for the DC field windings.

### BRIEF DESCRIPTION OF THE DRAWINGS

The description herein makes reference to the accompanying figures wherein like reference numerals refer to like parts throughout the several views.

FIG. 1 illustrates a schematic representation of a side view of a portion of an exemplary SynRel assembly according to an illustrated embodiment of the present application.

FIG. 2 illustrates a cross sectional view of the exemplary four pole SynRel assembly taken along line A-A in FIG. 1.

FIG. 3 illustrates a portion of the stator and rotor shown in FIG. 2.

FIGS. 4A-4C illustrate schematic representations of examples of various configurations for harmonic pickups along a length of a rotor of a SynRel assembly according to certain embodiments of the present application.

FIG. 5 illustrates a model of an exemplary rectifier in the form of a rectification circuit that is configured to convert air gap harmonic power that is harvested by pickup coil(s) of a SynRel assembly to DC excitation.

FIG. 6 illustrates an example of enhanced power factor and output torque that can be attained by a 25 kiloWatt (kW) field wound synchronous generator having a SynRel assembly of the present application.

FIG. 7 illustrates exemplary experimental results of a 30 kiloWatt (kW) field wound synchronous generator having an embodiment of a SynRel assembly discussed herein in which air gap harmonic power is harvested by a plurality of pickup coils.

The foregoing summary, as well as the following detailed description of certain embodiments of the present application, will be better understood when read in conjunction with the appended drawings. For the purpose of illustrating the application, there is shown in the drawings, certain embodiments. It should be understood, however, that the present application is not limited to the arrangements and instrumentalities shown in the attached drawings. Further, like numbers in the respective figures indicate like or comparable parts.

### DESCRIPTION OF THE ILLUSTRATED EMBODIMENTS

Certain terminology is used in the foregoing description for convenience and is not intended to be limiting. Words such as “upper,” “lower,” “top,” “bottom,” “first,” and “second” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

Embodiments disclosed herein include, but are not limited to, generally magnet-free configurations for SynRel machines that can enhance the power factor of the SynRel machines. Further, embodiments disclosed herein include configurations for SynRel machines that can generate flux within a rotor of the SynRel machine though the flow of DC excitation current through field windings in the rotor of the SynRel machine that is not provided by an external power source. Moreover, embodiments disclosed herein can use harmonic power harvested from an air gap between a stator and rotor of a SynRel machine to supply the rotor with a DC magneto motive force, which can be put in a rotor axis to enhance the power factor and torque rating of the SynRel machine.

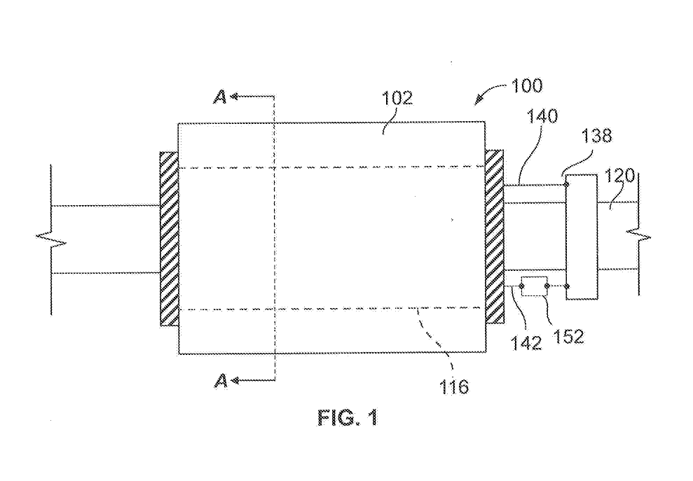

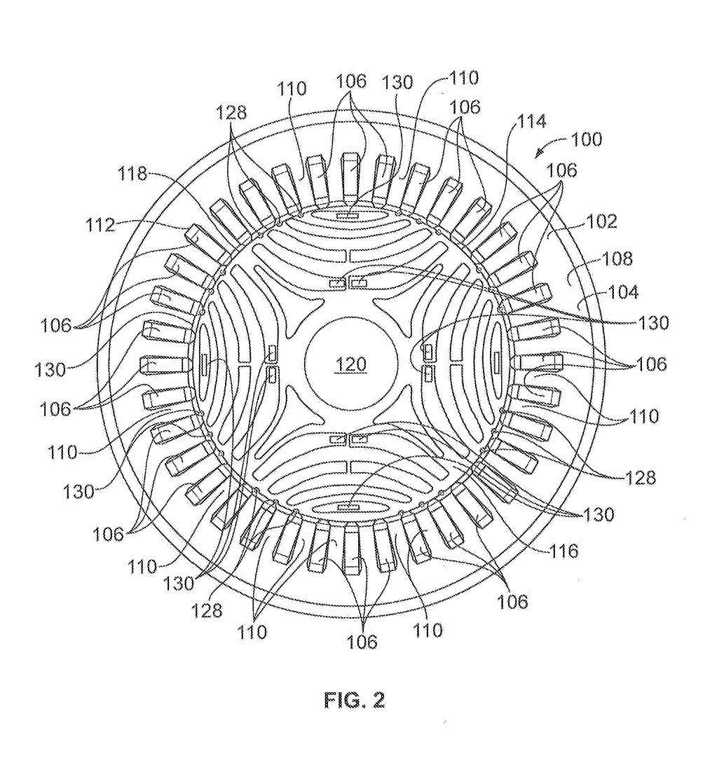

FIGS. 1 and 2 illustrate portions of an exemplary SynRel assembly 100 for a SynRel machine according to an illustrated embodiment of the present application. As shown, the SynRel assembly 100 includes at least a stator 102 having a stator core 104 and stator windings 106. According to certain embodiments, the stator core 104 is constructed from a plurality of electrically conductive laminations, including, but not limited to, steel laminations, as well as variations thereof. The stator core 104 can include a back iron 108 and a plurality of fingers 110, at least some of the fingers 110 being separated from an adjacent finger 110 by a gap 112 that is sized to receive at least a portion of the stator windings 106. The stator windings 106 can have a variety of configurations, such as, for example, but not limited to, being configured for two or three phase applications.

According to the illustrated embodiment, an inner portion of the fingers 110, or other portion of the stator core 104 proximally adjacent to the fingers 110, can generally define an inner bore 114 of the stator 102 that is sized to accommodate rotational displacement of at least a portion of a rotor 116 of the SynRel assembly 100. According to the illustrated embodiment, at least the portion of the rotor 116 that is positioned in the inner bore 114 of the stator 102 is separated from the stator 102 by an air gap 118. Similar to the stator 102, according to certain embodiments, the rotor 116 can comprise a plurality of rotor disks, such as, for example, a plurality of electrically conductive laminations, including, but not limited to, steel laminations, as well as variations thereof. According to the illustrated embodiments, the rotor 116 can be coupled to a shaft 120 such that rotation of one of the shaft 120 or the rotor 116 during operation of the SynRel assembly 100 and/or associated SynRel machine can be translated to at least rotational displacement of the other of the rotor 116 and the shaft 120.

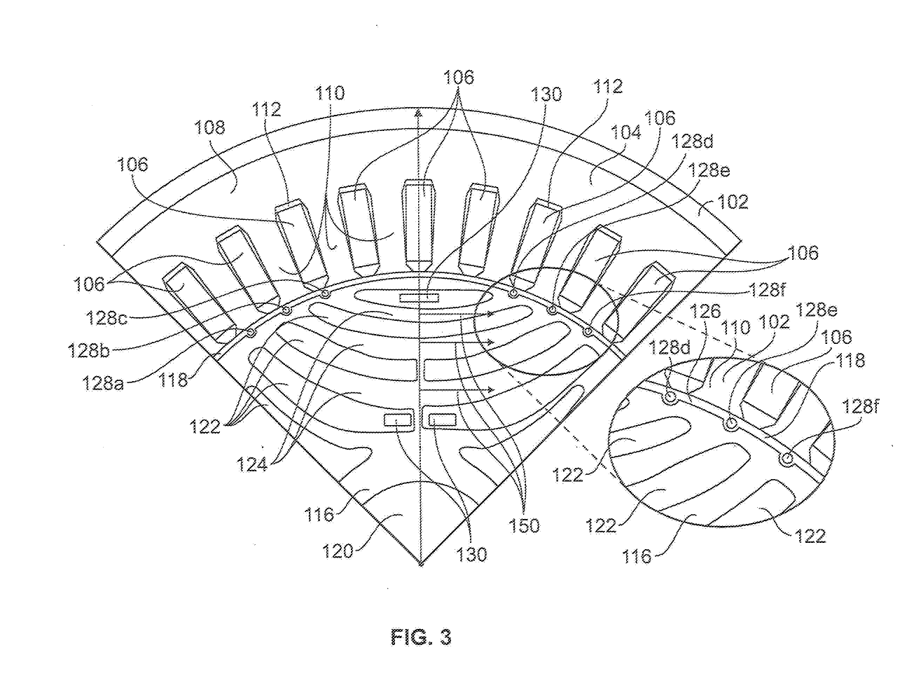

As shown in FIGS. 2 and 3, according to the illustrated embodiment, at least some of the rotor disks, and thus the rotor 116, include a plurality of flux barriers 122 that can be formed by openings in the rotor disks and/or rotor 116. According to certain embodiments, the flux barriers 122 of at least some of the rotor disks are in fluid communication with other the flux barriers 122 of other rotor disks so as to provide an airway path along at least a portion of the rotor 116 that can, for example, generally be occupied by air. Further, in addition to the exemplary orientation or configuration depicted in FIGS. 2 and 3, the flux barriers 122 can have a variety of different shapes and/or configurations, as well as be arranged at/in a variety of locations, orientations, and/or patterns relative to at least other flux barriers 122. Further, at least some of the flux barriers 122 can be generally defined by and/or separated from adjacent flux barriers 122 by longitudinal flux paths 124. The flux paths 124 can generally be interconnected to other flux paths 124, such as, for example, at least around an outer periphery 126 of the rotor disks, and thus the associated rotor 116, among other locations.

As shown by at least FIGS. 2 and 3, the SynRel assembly 100 further includes one or more pickup coils 128, 128a-f that is/are positioned adjacent, or proximally adjacent, to the air gap 118. The pickup coils 128, 128af can be structured to harvest harmonic energy that is in the air gap 118 between the rotor 116 and the stator 102. Moreover, the pickup coil(s) 128, 128a-f can be structured and positioned to harvest harmonic energy contained in flux that is generated by excitation current from the stator 102. Such harmonic energy can be harvested by the pickup coil(s) 128, 128a-f and used to provide energy for other components of the SynRel assembly 100. For example, according to certain embodiments, as discussed below, harmonic energy obtained by the pickup coil(s) 128, 128a-f can be used to provide power to DC field windings 130 of the rotor 116.

According to the illustrated embodiment, the pickup coil(s) 128, 128a-f can be constructed from a relatively high electrically conductive material, such as, for example, copper, among other materials. Further, although FIG. 3 illustrates the pickup coils 128a-f as separate wires, the pickup coils 128a-f can comprise a plurality of wires, windings, or coils. Further, at least some of the pickup coils 128a-f shown individually in FIG. 3 may be extensions of the same or other pickup coils 128a-f. Further, the direction of current flowing through each, or each portion, of the pickup coils 128a-f illustrated in at least FIG. 3 may be different that other wires, windings, or coils, or other illustrated portions thereof. For example, referencing FIG. 3, in at least certain embodiments, current may generally flow through at least some pickup coils 128a, c, e in a first direction and flow along other pickup coils 128b, d, f in a second direction that is opposite of the first direction.

As also shown by at least FIG. 3, according to the illustrated embodiment, the pickup coil(s) 128a-f can extend along an outer periphery 126 of the rotor 116, or along a portion of the rotor 116 that is proximally adjacent to the outer periphery 126 of the rotor 116. Moreover, according to certain embodiments, the rotor 116 can include one or more grooves, recesses, notches, or other indentations 132 in the outer periphery of the rotor 116 so that at least a portion of the pickup coil(s) 128a-f is recessed into the rotor 116 to a location that precludes the pickup coils 128a-f from contacting the stator 102 at least during operation of the SynRel assembly 100. For example, according to certain embodiments, the rotor disks may include at least a generally “U” shaped recess(es) that extends through the outer periphery 126 of the rotor 116. Alternatively, according to other embodiments, some or all of the one or more recesses 132 may not extend through the outer periphery such that the pickup coil(s) 128a-f is/are generally embedded or submerged within the rotor 116 and/or rotor disks.

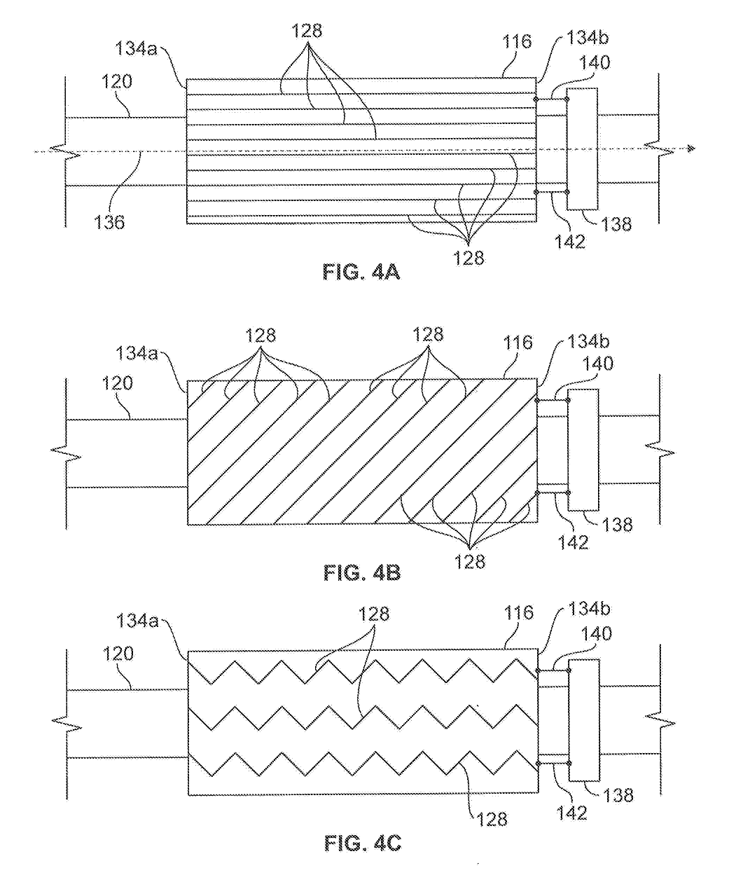

As indicated for at least purposes of illustration in FIGS. 4A-4C, the pickup coil(s) 128, 128a-f can extend at least along a portion of a length between first and second ends 134a, 134b of the rotor 116 in a variety of different manners, including in a variety of different configurations, groupings, patterns, and/or orientations. For example, according to the embodiments shown in FIGS. 4A-4C, a plurality of pickup coils 128a-f can extend between the first end 134a and the second end 134b of the rotor 116. However, according to other embodiments, the pickup coils 128a-f may only extend from one of the first end second ends 134a, 134b of the rotor 116, or may extend only along a portion of the rotor 116 between the first and second ends 134a, 134b. As shown in FIG. 4A, according to certain embodiments, the pickup coils 128a-f may be oriented to extend along the rotor 116 in a direction that is generally parallel to a central longitudinal axis 136 of the rotor 116. Alternatively, one or more of the pickup coils 128a-f may be wound or otherwise have a helical or spiral orientation such that the pickup coils 128a-f are wrapped around at least a portion of the rotor 116, as shown, for example, in FIG. 4C. Alternatively, the direction or orientation of the pickup coils 128a-f may vary or alternate as the pickup coils 128a-f extend along the rotor 116, as shown, for example, in FIG. 4C. The pickup coils 128a-f however can be arranged in a variety of other patterns or arrangements, as well as combinations thereof, in addition to, or other than, those shown in FIGS. 4A-4C.

According to the illustrated embodiment, the energy harvested by the pickup coils 128a-f is AC current. Accordingly, the pickup coil(s) 128a-f can be electrically coupled to a rectifier 138, such as, for example, a passive or controlled rectification circuit, among other types of rectifiers, as generally indicated, for example, by the representation of a wired connection 140 between the pickup coil(s) 128a-f and the rectifier 138 shown in at least FIG. 1. The rectifier 138 can be configured to convert AC current provided to the rectifier 138 via the pickup coil(s) 128a-f to DC current that can be supplied to a DC field coil 130 of the rotor 116, as discussed below. According to certain embodiments, the rectifier 138 does not receive electrical power from an external power source, but instead relies on the supply of power that is harvested by the pickup coil(s) 128a-f. Further, according to certain embodiments, the rectifier 138 can be external to the rotor 116. According to such embodiments, the rectifier 138 can be coupled to the shaft 120 or coupled to another component that is coupled to the shaft 120. Alternatively, according to certain embodiments, the rectifier 138 can be mounted to, or in, the rotor 116.

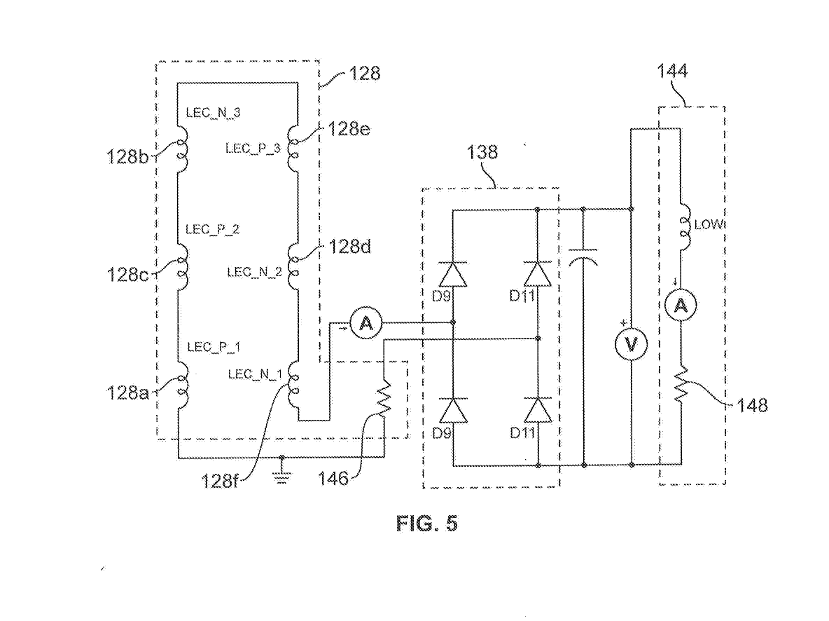

FIG. 5 depicts, for at least purposes of illustration, a model of an exemplary rectifier 138 that is configured to convert harmonic power that is at least in the air gap 118 between the stator 102 and the rotor 116, and which is harvested by the pickup coil(s) 128, 128a-f, to DC excitation current. The model includes modeling of pickup coils 128, as indicated by the plurality of inductors (LEC_P_(1-3) and LEC_(1-3)). According to at least certain models, the pickup coils 128 depicted in FIG. 5 can correspond to the pickup coils 128a-f depicted in at least FIG. 3. The modeled pickup coils also include a resistor 146 to model resistive loss in the actual pickup coils 128 of the SynRel assembly 100, such as, for example, resistive losses associated with the use of copper coil, wire, or windings, among other materials, that is used in the construction of the pickup coils 128. The model further includes rectifier 138 in the form of a model rectification circuit, which can be, for example, a single phase or mulitphase rectifier. However, a variety of other rectifiers 138, including, but not limited to, three phase rectifiers or multiphase rectifiers, can be utilized by, or for, the rectifier 138.

Additionally, although embodiments disclosed herein are discussed in terms of the rectifier 138 being a passive or controlled rectification circuit, according to other embodiments, the rectifier 138 can be an active or power electronics converter. Additionally, depending on the application, a power electronic converter utilized for the rectifier 138 can be configured to coordinate operation of the SynRel assembly 100, and thus the associated SynRel machine, with other system components. For example, in applications in which a SynRel machine having a SynRel assembly 100 is used as part of a wind turbine generator (WTG), the rectifier 138 can be a power electronics circuit that can include a controller that is configured to coordinate with a drivetrain converter of the system for optimal operation of the WTG at various wind speeds. According to certain embodiments, by using an active or power electronics converter, the flow of DC excitation current from the rectifier 138 that is used to generate and/or control the magnitude of the generated flux, can be coordinated with the operation of the drivetrain converter of the WTG and/or coordinated with the conditions, including, for example, environmental conditions, in which the WTG is operating. Such coordination between at least the rectifier 138 and the drivetrain converter can, in at least certain situations, control the timing of weakening of the flux generated by the flow of DC excitation current through the DC field windings 130, and thus improve annual energy efficiencies, such as, for example, improve operation of the WTG at maximum torque per amp (MTPA). Further, the ability to coordinate the generation of such flux can provide a degree of freedom or control in the operation of associated SynRel machine that may not be attainable by at least magnet assisted SynRel machines. For example, according to at least certain embodiments, the ability to coordinate generation of flux can facilitate flexible control of rotor flux in a manner that can at least assist in the SynRel machine attaining a relatively high speed range. Further, the ability to attain a relatively high speed range for the SynRel machine via coordinated generation of such flux can be beneficial in a number of applications, including, but not limited to, automotive applications.

According to certain embodiments, the SynRel assembly 100 and/or the rectifier 138 can be configured to include, or be electrically coupled to, a power conditioner 152 that is structured to provide a degree of power conditioning for the flow of DC excitation current. For example, according to certain embodiments, the rectifier 138, or other components or circuitry of the SynRel assembly 100, can be configured to provide a high grade of power conditioning at a location between the pickup coil(s) 128, 128a-f and the DC field windings 130. According to certain embodiments, such power conditioning can be attained, for example, through the use of Maximum Power Point Tracking (MPPT).

The model shown in FIG. 5 further includes a load 144 being coupled to the exemplary rectifier t 138. According to an illustrated embodiment, the load 144 can be modeled after one or more DC field windings 130, as indicated by the inductor (LOW), which can extend through at least a portion of the rotor 116, as discussed below. Additionally, the model of the load 144 can be configured to account for resistive losses via the inclusion of a resistor 148, such as, for example, resistive losses associated with the use of copper coil, wire, or windings, among other materials, in the construction of the DC field windings 130.

According to the illustrated embodiment, the depicted rectifier 138 is a rectification circuit that is electrically coupled to one or more DC field windings 130, such as, for example, by a wired connection 142, as depicted for at least purposes of illustration in at least FIG. 1. As shown in at least FIG. 3, the DC field windings 130 can extend, or be wound, through one or more flux barriers 122. The number of the DC field windings 130, as well as the location of the DC field windings 130, within the flux barriers 122, as well as which of the flux barriers 122 do or do not have DC field windings 130, can vary. The DC field windings 130 can have a variety of different shapes and configurations. For example, according to certain embodiments, the DC field windings 130 can have a shape that corresponds to and/or mates the shape of at least a portion of the flux barriers 122 in which the DC field windings 130 are positioned. Such configurations can enhance the ease with which the DC field windings 130 may be assembled in, or about, the rotor 116 and/or rotor disks, as well as improve the fill factor in the flux barriers 122, particularly with respect to flux barriers 122 that have irregular and/or relatively complex geometries. Additionally, such shaping and/or configuration of the DC field windings 130 can be attained in a variety of different manners or techniques, including, but not limited to, molding, forming, machining, extrusion, and/or 3D printing, among other manners or techniques.

Power harvested by the pickup coils 128 can provide power to the rectifier 138, such as, for example, a passive or controlled rectification circuit, that converts the AC current to DC current that then flows through the DC field windings 130. Additionally, the DC excitation current flowing through the DC field windings 130 can generate a flux in the rotor 116, as depicted for purposes of illustration by the flux vectors 150 in FIG. 3. While the flux vectors 150 depicted in FIG. 3 are illustrated as generally being aligned with the quadrature axis, the rotor 116 and/or SynRel assembly 100 can be configured to accommodate flux vectors 150 in other directions, or combinations of directions. Moreover, the orientation and/or location of the DC field windings 130, flux barriers 122, and/or flux paths 124 can be configured to facilitate the direction(s) of one or more flux vector(s) 150. For example, according to certain embodiments, the rotor 116 and/or DC field windings 130 can be configured to produce one DC flux vector 150 by the flow of DC excitation current through the DC field windings 130, or, alternatively, multiple discrete and/or diverse DC flux vectors 150 could be generated in at least an attempt to maximize their effect on at least the power factor of the SynRel machine and/or improve the performance of at least the SynRel assembly 100. Moreover, such a configuration can allow for generation of a flux in the rotor 116 of the SynRel assembly 100 in a manner other than through the use of magnets and/or the flow of current from an external power source through the DC field windings 130.

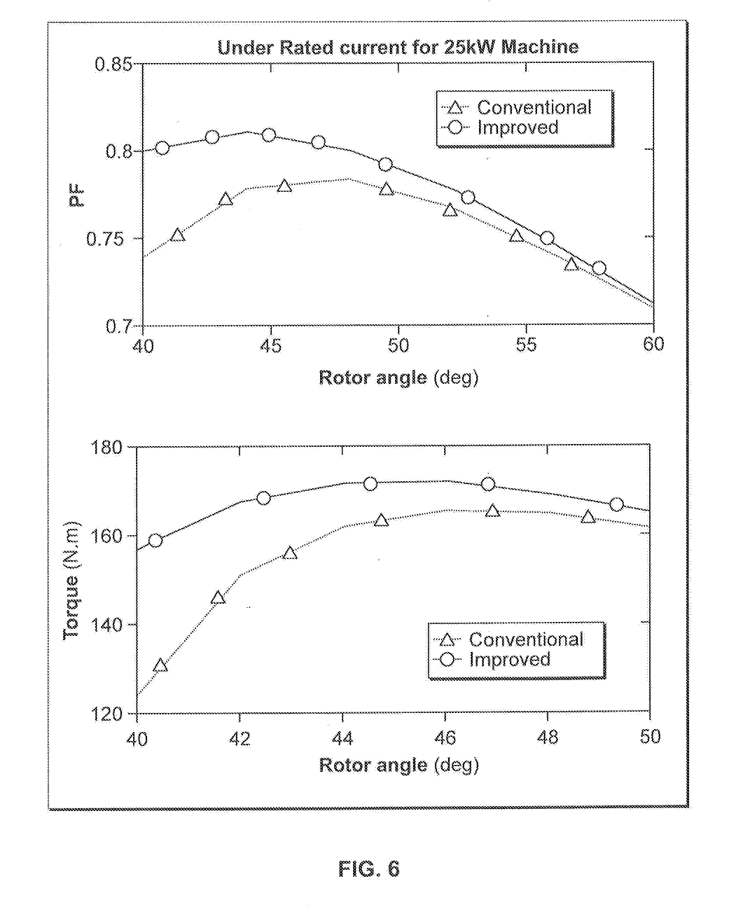

FIG. 6 illustrates an example of enhanced power factor and output torque that, when compared to conventional permanent magnet synchronous machines, can be attained by a synchronous generator having a SynRel assembly 100 that includes one or more harmonic pickup coils 128, 128a-f and one or more DC field windings 130 in the rotor 116. The results of the illustrated simulation is based on a 25 kiloWatt (kW) SynRel machine having a SynRel assembly 100, and was conducted under an assumption that the fill factor in rotor 116 is 0.5, and current density is 4 ampere per millimeter squared (A/mm̂2), which, when assuming the use of copper for the harmonic pickup coils 128, 128a-f and DC field windings 130, translates into a resistive loss of around 0.2% of total output power. As illustrated, as the rotor angles increase, both the power factor and the torque of the SynRel machine having a SynRel assembly 100 at least approaches the power factor and the torque levels of permanent magnet synchronous machines. Further, in view of such results, in megawatt generator applications, the rotor coil loss of the SynRel assembly 100 can be smaller in percentage wise, and the benefit of power factor improvement can be even more significant.

By providing an enhanced power factor without at least use of, the SynRel assembly 100 can avoid costs associated with the inclusion of such magnets while also improving the efficiency of the associated SynRel machine. Further, by improving the power factor of the SynRel machine without the inclusion of magnets, the associated SynRel machine can be thermally and electromagnetically reliable from demagnetization aspects. Additionally, according to embodiments in which magnets are not being placed in the flux barriers 122, the shape and/or orientations of the flux barriers 122 are not limited to the geometric configuration(s) of the magnets, thereby increasing design freedom in at least the direction(s) of the DC flux vector(s) 150. Further, such design can increase the design freedom and boundary conditions for the electromagnetic and structural design of the SynRel assembly 100, such as, for example, the pole numbers and bridge thickness that are power factor relevant.

While certain embodiments discussed herein have been discussed in terms of being generally magnet-free, according to other embodiments, the SynRel assembly 100 can be a hybrid assembly that also utilizes magnets or other magnetic materials to improve the power factor of the SynRel machine and/or the SynRel machine. Moreover, according to certain embodiments, the rotor 116 of the SynRel assembly 100 can include pickup coils 128 and DC field windings 130 that are coupled to the rectifier 138, as well as one or more magnets or conductor coils.

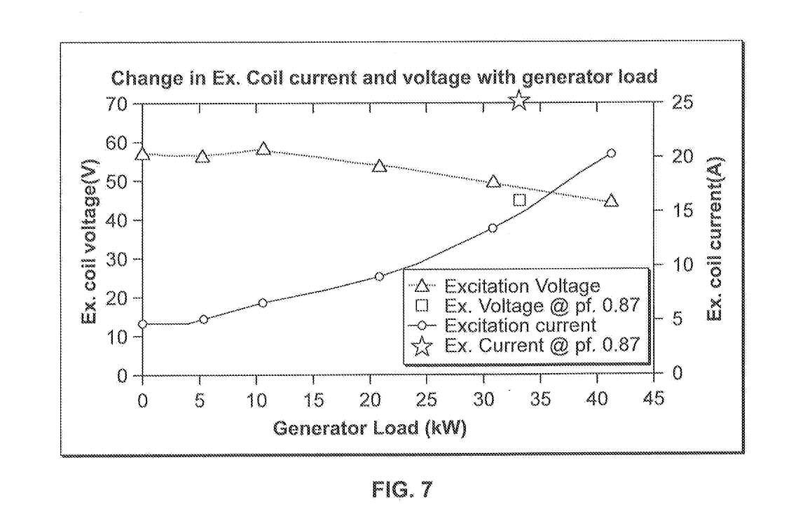

FIG. 7 illustrates exemplary experimental results of a 30 kiloWatt (kW) field wound synchronous generator having a SynRel assembly 100 in which air gap harmonic power is harvested by a plurality of pickup coils 128, 128a-f. The graph in FIG. 7 depicts excitation (“Ex.”) coil voltage (in volts (V)) and excitation coil current (in amps (A)) at a power factor (“pf”) of 0.87, the change in excitation coil current and voltage with generator load, and the generator load. As shown by FIG. 7, in the illustrated embodiment, the harmonic power harvested from the air gap 118 by the pickup coils 128, 128a-f is more than ample to supply the field winding for up to 1.5 times of generator loading. Further, the harmonic power generally required for performance compensation in at least the discussed SynRel assembly 100 of the SynRel machine generally is not as significant as that for supplying field winding power for a traditional synchronous generator.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

1. An assembly for a synchronous reluctance machine comprising:
a rotor;
at least one pickup coil coupled to the rotor, the at least one pickup coil positioned at least proximally adjacent to an outer periphery of the rotor and structured to harvest energy in an air gap adjacent to the outer periphery of the rotor during operation of the synchronous reluctance machine; and
at least one DC field winding electrically coupled to the at least one pickup coil, the at least one DC field winding extending through an inner portion of the rotor and configured to generate flux within the rotor using the harvested energy from the at least one pickup coil.

2. The assembly of claim 1, further including a rectifier electrically coupled to the at least one pickup coil and the at least one DC field winding, the rectifier structured to convert the harvested energy from the at least one pickup coil into a DC excitation current that is delivered to the at least one DC field winding.

3. The assembly of claim 2, wherein the rectifier comprises a passive or controlled rectification circuit.

4. The assembly of claim 2, wherein the rectifier comprises an active rectifier or a power electronics converter.

5. The assembly of claim 2, wherein the at least one pickup coil is positioned in a recess in the outer periphery of the rotor.

6. The assembly of claim 2, wherein the at least one pickup coil is embedded below the outer periphery of the rotor.

7. The assembly of claim 2, wherein the at least one DC field winding is position in at least one of a plurality of flux barriers in the rotor.

8. The assembly of claim 7, wherein the at least one DC field winding has a shape that mates a shape of at least a portion of the flux barrier of the plurality of flux barriers at which the at least one DC field winding is to be positioned.

9. The assembly of claim 2, further including at least one magnet positioned in at least one of the plurality of flux barriers.

10. The assembly of claim 2, further including a power conditioner configured to improve the quality of the DC excitation current delivered to the at least one DC field winding.

11. An assembly for a synchronous reluctance machine comprising:
a stator having an inner bore;
a rotor having an outer periphery, the outer periphery sized to accommodate rotational displacement of at least a portion of the rotor within the inner bore, the outer periphery further sized for at least a portion of the rotor that is operably positioned in the inner bore to be separated from the stator by an air gap; and
one or more pickup coils coupled to the rotor and extending at least proximally adjacent to the outer periphery of the rotor, the one or more pickup coils structured to harvest energy in the air gap generated during operation of the synchronous reluctance machine.

12. The assembly of claim 11, further including one or more DC field windings electrically coupled to the one or more pickup coils, the one or more DC field windings extending through an inner portion of the rotor and configured to generate flux within the rotor using the harvested energy from the one or more pickup coils.

13. The assembly of claim 12, further including a rectifier electrically coupled to the one or more pickup coils and the one or more DC field windings, the rectifier structured to convert AC current from the harvested energy from the one or more pickup coils into a DC excitation current that is delivered to the one or more DC field windings.

14. The assembly of claim 13, wherein the rectifier comprises a passive or controlled rectification circuit.

15. The assembly of claim 13, wherein the rectifier comprises an active rectifier or a power electronics converter.

16. The assembly of claim 12, wherein the rotor includes a plurality of flux barriers, at least a portion of the one or more DC field windings extending through at least a portion of the plurality of the flux barriers, and further including at least one magnet positioned in at least one of a plurality of flux barriers.

17. An assembly for a synchronous reluctance machine comprising:
a stator having an inner bore;
a rotor having a plurality of flux barriers, a plurality of pickup coils, and a plurality of DC field windings, the plurality of DC field windings extending through at least a portion of the plurality of flux barriers, the plurality of pickup coils being adjacent to an outer periphery of at least a portion of the rotor that is sized for rotational displacement within the inner bore of the stator, the plurality of pickup coils structured to harvest energy from at least an air gap in the inner bore between the stator and the rotor; and
a rectifier electrically coupled to the plurality of pickup coils and the plurality of DC field windings, the rectifier structured to convert AC current of the harvested energy from the pickup coils to DC excitation energy for the DC field windings.

18. The assembly of claim 17, wherein the plurality of pickup coils are positioned in one or more recesses in the outer periphery of the stator.

19. The assembly of claim 17, wherein the rectifier comprises a passive or controlled rectification circuit.

20. The assembly of claim 17, further including at least one magnet positioned in at least one of the plurality of flux barriers.
